(19) United States
(12) Patent Application Publication
(10) Pub. No.: US 2024/0385661 A1
(43) Pub. Date: Nov. 21, 2024

(54) ELECTRONIC DEVICE INTERACTION & PASS THROUGH ACCESSORY

(71) Applicant: Apple Inc., Cupertino, CA (US)

(72) Inventors: Santhana K. Balaji, Campbell, CA (US); Anna C. Widder, Sunnyvale, CA (US); Kevin W. Stanley, San Francisco, CA (US); Nicholas A. Treadwell, San Jose, CA (US); Fernando F. Cunha, Santa Clara, CA (US)

(21) Appl. No.: 18/429,726

(22) Filed: Feb. 1, 2024

Related U.S. Application Data
(60) Provisional application No. 63/503,310, filed on May 19, 2023.

(51) Int. Cl. G06F 1/16

(52) U.S. Cl. CPC G06F 1/1683; G06F 1/1698

(57) ABSTRACT

A modular electronic device system can include: a portable computing device comprising a rear surface and a sidewall surface; and an electronic case sized and shaped to engage at least the rear surface of the portable computing device. The electronic case is configured to augment a signal into or out of the portable computing device.

### CROSS-REFERENCE TO RELATED APPLICATION(S)

This claims priority to U.S. Provisional Patent Application No. 63/503,310, filed 19 May 2023, and entitled “Electronic Device Interaction & Pass Through Accessory,” the entire disclosure of which is hereby incorporated by reference in its entirety.

### FIELD

The described embodiments relate generally to electronic accessories and covers for computing devices. More particularly, the present embodiments relate to a case that includes pass-thru capabilities between an accessory device and a computing device housed within the case.

### BACKGROUND

Portable computing devices have grown in popularity and ubiquity worldwide in recent years. The convenience and adaptability of portable computing devices such as tablet computers and smart phones have therefore helped serve the needs of users for many purposes. It is also common to use a case or cover on a computing device to protect it from bumps, drops, scrapes, scratches, and other damage. Although protective in nature, conventional cases provide no additional or improved functionality with respect to operation of the computing device. Rather, in some instances, conventional cases can even inhibit compatibility with certain accessory devices, such as wireless charging devices, keyboard devices, etc. (e.g., due to interference from the case or an undesirable connection to the computing device). As a result, there is a constant need for improvements in portable computing devices, particularly for associated cases of these systems.

### SUMMARY

One or more examples of the present disclosure relates to a modular electronic device system. The modular electronic device system can include: a portable computing device comprising a rear surface and a sidewall surface; and an electronic case sized and shaped to engage at least the rear surface of the portable computing device, wherein the electronic case is configured to augment a signal into or out of the portable computing device. In some examples, the signal includes an electrical signal, a light signal, or a sound signal; and the electronic case includes at least one of an electrical connector, a lens adapter, or an acoustic chamber. In these or other examples, the portable computing device includes a first electrical connector positioned on one of the sidewall surface or the rear surface; the electronic case includes a second electrical connector electrically connectable to the first electrical connector, the second electrical connector positioned on an interior portion of the electronic case; and a third electrical connector is positioned on an exterior portion of the electronic case, the third electrical connector being electrically connected to the second electrical connector, and the third electrical connector being electrically connectable to a fourth electrical connector of an accessory device.

In certain examples, the first electrical connector includes a first throughput capacity for power or data transmission; and the third electrical connector includes a second throughput capacity for the power or data transmission, the second throughput capacity being greater than the first throughput capacity. In at least one example, upon connection of the third electrical connector to the fourth electrical connector, the portable computing device is configured to receive a connection signal from the accessory device through each of the first, second, third, and fourth electrical connectors; and in response to receiving the connection signal, the portable computing device is configured to update a display profile specific to the accessory device. In a particular example, the electronic case further includes an authentication chip in electrical communication with at least the third electrical connector, the authentication chip configured to: verify the connection signal from the accessory device; and transmit an authentication signal to the portable computing device.

In one example, the third electrical connector includes a greater amount of contact surface area relative to the first electrical connector. In a further example, the modular electronic device system includes an electrical controller positioned between the second electrical connector and the third electrical connector, the electrical controller being configured to alter an electrical signal passing between the accessory device and the portable computing device. In at least some examples, the electronic case includes a first sidewall and a second sidewall; the second electrical connector is positioned on an interior surface of the first sidewall; and the third electrical connector is positioned on an exterior surface of the second sidewall. In one or more examples, the electronic case includes: a sidewall configured to engage the sidewall surface of the portable computing device; and a backing configured to engage the rear surface of the portable computing device. In certain examples, the second electrical connector is positioned on an interior surface of at least one of the sidewall or the backing; and the third electrical connector is positioned on an exterior surface of at least one of the sidewall or the backing.

The present disclosure additional relates to an electronic case. An electronic case can include: a rear surface; sidewalls protruding perpendicularly away from the rear surface; and an interior portion defined by the rear surface and the sidewalls, the interior portion sized and shaped to receive a body portion of a portable computing device. The electronic case can further include: an exterior surface opposing the interior portion; and a sensor disposed within the interior portion or embedded within one of the sidewalls, the sensor comprising a wireless detection range that extends at least to the exterior surface. In one or more examples, the sensor is configured to: detect an accessory device when the accessory device is positioned within the wireless detection range of the sensor; and transmit a signal to the portable computing device, the signal identifying the accessory device and a user interface setting associated with the accessory device.

In one or more examples, the accessory devices includes an electronic stylus. In a further example, the sensor is configured to detect a first magnetic array for a first accessory device and a second magnetic array for a second accessory device. In one example, the electronic case further includes a set of magnets embedded in at least one of the sidewalls. In another example, the user interface setting includes at least one of a color preference, font preference, notification preference, or contact directory preference. In at least one example, the electronic case includes an additional sensor embedded within the rear surface, the additional sensor configured to: detect a magnetic field emitted from an accessory device; and transmit at least one of a wake signal or a sleep signal in response to detecting the magnetic field.

The present disclosure also relates to another modular electronic device system. The modular electronic device system can include a tablet computing device and an electronic case. The tablet computing device can include: a body portion including a rear surface; and a display portion positioned opposite the rear surface, the display portion configured to generate a first graphical representation for display within a user interface, the first graphical representation corresponding to a first display profile. The electronic case can include: a panel sized and shaped to cover at least the rear surface of the tablet computing device; and a sensor disposed on or within the panel, the sensor configured to detect an accessory device. In some examples, the sensor is configured to generate a signal receivable by the tablet computing device in response to detection of the accessory device; and in response to receiving the signal, the tablet computing device is configured to update the user interface by generating a second graphical representation for display, the second graphical representation corresponding to a second display profile that differs from the first display profile.

In these or other examples, the modular electronic device system further includes a housing that includes the panel and sidewalls integrated with the panel, at least one of the sidewalls defining an acoustic chamber to amplify or spatially direct sound waves into or away from the tablet computing device. In some examples, the acoustic chamber includes a tapered cross-section defined by internal walls within the housing. In at least one example, the acoustic chamber includes: a first opening oriented towards an interior portion of the housing; and a second opening oriented towards an exterior portion of the housing, wherein the second opening is smaller than the first opening. In one or more examples, the housing includes: an electrical contact exposed on an interior surface of the housing; electrical circuitry connected to the electrical contact, the electrical circuitry embedded within the housing; and an exterior button that, when actuated, triggers an electrical signal through the electrical circuitry to the electrical contact. In one example, the electronic case further includes an additional sensor configured to detect a biomarker. In some examples, the biomarker is associated with a human finger. In at least one example, the exterior button is sensorally transparent to the additional sensor to allow detection of the biomarker.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates an example modular electronic device system;

FIG. 2 illustrates an example modular electronic device system in which a computing device updates a user interface in response to connecting to an accessory device;

FIG. 3 illustrates an example modular electronic device system in which a computing device updates a user interface in response to connecting to an electronic case;

FIG. 4 illustrates a front view of an example electronic case;

FIG. 5 illustrates a front view of another example electronic case;

FIG. 6 illustrates a side profile view of portions of an electronic case and a computing device comprising respective buttons;

FIG. 7 illustrates a perspective view of an example electronic case;

FIG. 8 illustrates a portion of a computing device housed within an electronic case;

FIG. 9 illustrates a portion of a computing device housed within an electronic case that includes a lens adapter; and

FIG. 10 illustrates a high-level block diagram of a computer system configured to implement one or more aspects of the present disclosure.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates in part to cases for computing devices that can implement a variety of electrical connectors, sensors, and functional components (e.g., magnets). Although reference herein is made to cases or electronic cases, the cases may alternatively be embodied as a shell or cover for the computing device. Such elements can be used to provide a myriad of different device interactions and pass-thru capabilities—at least some of which the computing device alone would be unable to provide. To illustrate, many computing devices include a wide array of design constraints, including size, weight, available materials, etc. This is especially true where consumers desire technology with increased portability and on-the-go usability. As a result, computing devices are often limited in terms of certain functionality because limited space on or within the computing device does not afford certain components.

The cases of the present disclosure can improve or augment the functionality of a computing device. For example, with additional volume and surface area, the electronic case can implement a desired configuration of electrical connectors positioned on internal and external regions of the electronic case. In so doing, the case can be implemented with or connectable to a variety of different accessory devices (e.g., keyboards, payment devices, cameras, etc.), but without the need for adapters, dongles, and other compatibility devices. Likewise, the additional space and volume on or within the electronic cases can afford various sensors (e.g., Hall Effect sensors, magnetometers, accelerometers, fingerprint scanners, etc.) for providing additional functionality to a computing device, such as user identification from a button-touch. Further, the electronic case can include structural elements, such as acoustic chambers for sound modification (e.g., amplification, spatial redirection), more magnets for increased magnetic attraction or improved alignment to accessory devices, and the like.

In at least some examples, the electronic case of the present disclosure can help provide a customized user experience. For example, the electronic case (when coupled with a computing device) can cause the computing device to generate a particular graphical representation for display within a user interface of the computing device—where the graphical representation is specific to the electronic case. To illustrate, a blue electronic case can cause the computing device to display a blue background or a blue-themed application. As another example, the electronic case of the present disclosure can cause the computing device to generate a particular graphical representation for display within a user interface of the computing device—where the graphical representation is specific to an accessory device. Alternatively, the computing device can be configured to react to the connection of the accessory device or case based on detecting a feature or characteristic of the device or case using a sensor of the computing device. For instance, the electronic case can cause the computing device to display a particular type of application (e.g., game applications) when connected to particular associated accessories (e.g., a gaming keyboard) and can display a second type of application (e.g., business applications) when connected to a different type of associated accessories (e.g., a work keyboard).

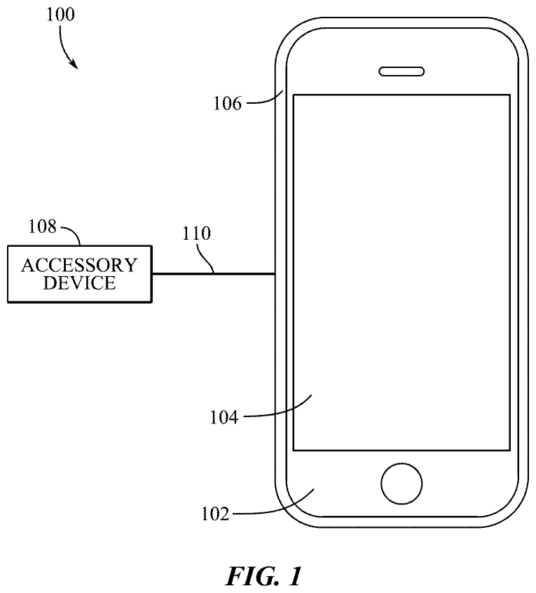

These and other embodiments are discussed below with reference to FIGS. 1-10. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a modular electronic device system 100 in accordance with one or more examples of the present disclosure. As shown, the modular electronic device system 100 includes a computing device 102. In particular implementations, the computing device 102 includes a mobile or portable computing device, such as a cell phone device or a tablet computing device. However, the computing device 102 can include one or more of a variety of different types of computing devices, such as notebook computers, desktop computers, smart phones, servers, similar devices, and combinations thereof. Indeed, the computing device 102 is shown merely as an example device with which aspects of the present disclosure are illustrated for convenience in providing an explanation and should not be viewed as limited to a tablet computing device or smart phone.

In at least some examples, the computing device 102 includes a display portion or display module having a display 104. Example types of a display include a light emitting diode (LED) display, quantum dot LED (QLED) display, organic LED (OLED) display, a liquid crystal display, digital light processing display, plasma panel display, rear-projection display, a micro display, similar displays, or combinations thereof. The display 104 can further include various components for rendering a graphical representation which defines a visual arrangement of a set of pixels in response to computer-executable instructions and/or user-input. Examples of a graphical representation can include images, text, animations, emojis, notifications, banners, icons, etc. The depiction of one or more graphical representations at the display 104 can define a user interface, which comprises the composite of graphical representation(s) accessible for viewing and/or user interaction at the display 104. A user interface can specifically include a graphical user interface, touchscreen graphical user interface, menu-driven interface, command line interface, form-based interface, natural language interface, etc.

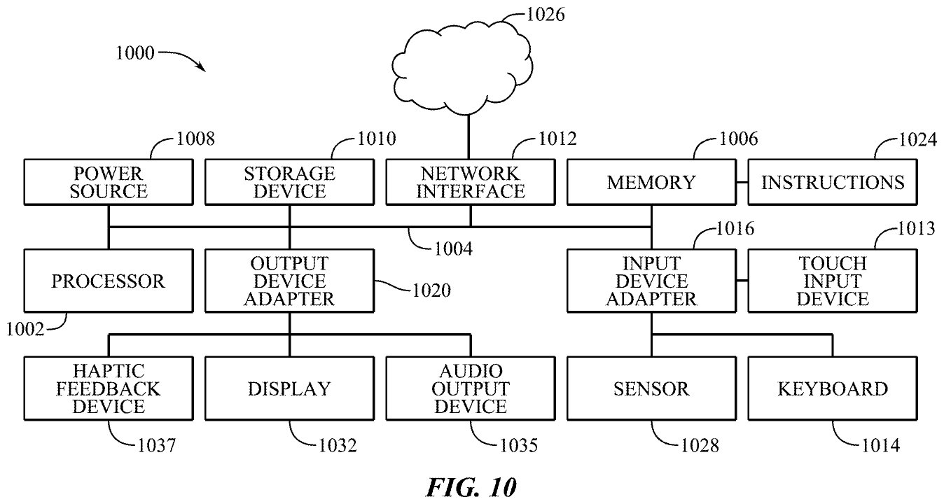

Additional aspects of a computing device (as well as an electronic case or an accessory device) are described further below in relation to subsequent figures, including FIG. 10. For example, one or more of the components of the modular electronic device system 100 can include a processor, memory device, electronic storage device, portable power source or power source connector, circuit boards, electrical switches and circuitry, and other components of system 1000 of FIG. 10.

The modular electronic device system 100 can further include an electronic case 106. The electronic case 106, as disclosed herein, can include a removable cover, housing, panel, skin, protector, another protective shell, similar enclosure, or combinations thereof that is sized and shaped to receive the outer body or housing of the computing device 102. Unlike conventional cases, however, an electronic case of the present disclosure is electronic-meaning the electronic case 106 comprises electrical circuitry and/or electrical components for at least one of receiving or transmitting electrical signals. In this regard, the electronic case 106 can serve as an active medium—as opposed to a passive medium like conventional cases-through which electrical signals can be actively received and/or actively transmitted relative to a computing device or an accessory device.

In some examples, the electronic case 106 can have a rear portion (or rear surface) configured to overlap and at least partially cover or enclose a rear surface of the computing device 102. In some embodiments, the rear portion of the electronic case 106 can cover all (or substantially all) of the rear surface of the computing device 102 (e.g., all of the rear surface of the computing device 102 except for a cutout for a camera or another rear-facing sensor). The electronic case 106 can therefore act as a barrier preventing other objects from contacting and potentially damaging at least the rear surface of the computing device 102. The case 106 may be removable and reattachable to the computing device 102 without damage to the case or computing device, and the computing device 102 may be operated normally without the case 106 being attached to it.

In some examples, the electronic case 106 can include one or more sidewalls. As used herein, the term “sidewall” in connection to the electronic case 106 refers to a member that is configured to at least partially cover or overlap with a lateral side of the computing device 102. A combination of sidewalls can be implemented (e.g., to at least partially wrap around each lateral side of the computing device 102). In some embodiments, the lateral sides are positioned surrounding a front face of the device 102 through which the display 104 is viewed by the user and extend between the front face and the rear face positioned opposite the front face.

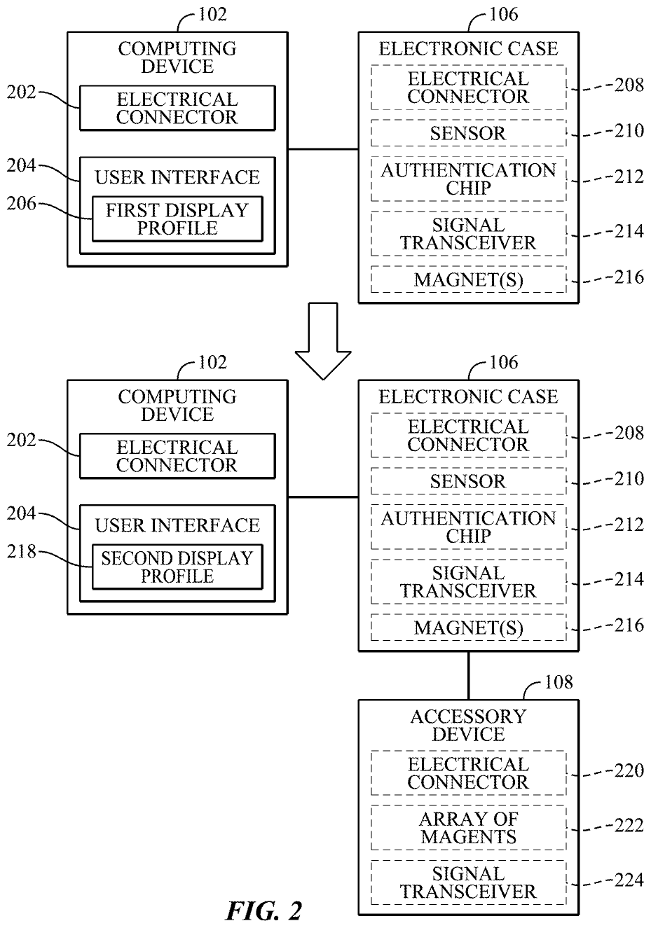

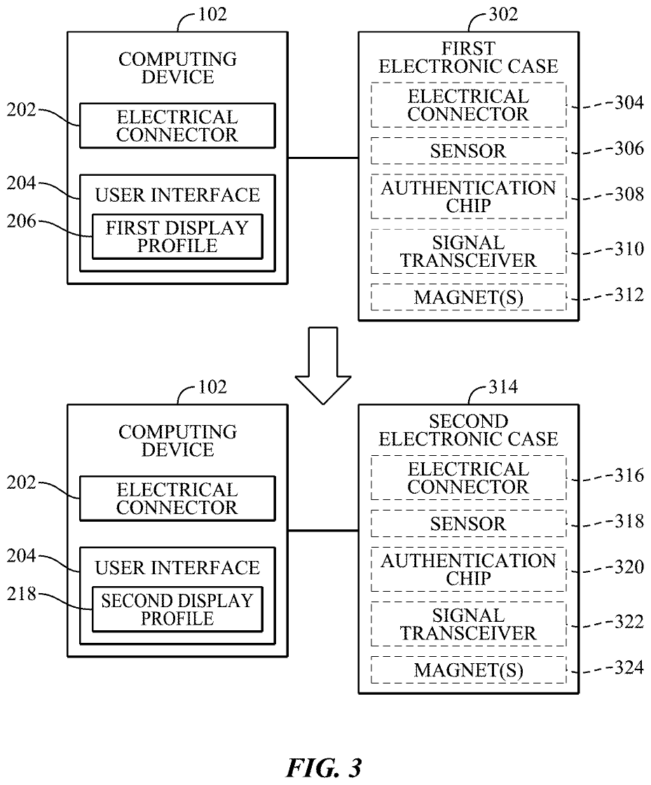

In some examples, the electronic case 106 can cause the computing device 102 to update a user interface, such as with one or more different graphical representations. For example, as described below in relation to FIG. 2, the computing device 102 can update a user interface to include a graphical representation based on a detected accessory device. As another example (described below in relation to FIG. 3), the computing device 102 can update a user interface to include a graphical representation based on a detected electronic case.

In these or other examples, the electronic case 106 can include various components to augment a signal into or out of the computing device 102. As will be discussed below, augmentation of a signal can include augmentation of an electrical signal, a light signal, a sound signal, etc. Thus, as will be described below, the electronic case 106 can include sensors, electrical circuitry, controllers, transceivers, transducers, and/or other electrical components. Augmentation can include amplifying the magnitude of a signal (or a subset or portion of the signal, such as a certain range of frequencies of a sound or light), reducing a signal (or a subset or portion thereof), and converting a signal from one state to another state (e.g., from one electronic communication standard to another electronic communication standard). In some examples, amplifying the magnitude (or frequency) of the signal can include increasing a sound volume, outputting a greater amount of illumination, flashing light at quicker speeds or intervals, etc., to name a few potential implementations. By contrast, reducing a signal can include dampening the magnitude or slowing the frequency of a signal-effective to lower a sound volume, filter a frequency band of ambient noise, lessen an illumination output, slow a flashing light speed, etc. Further, in some examples, converting a signal from one input-output state to another input-output state can include or converting a haptic input (e.g., a touch, swipe, or tap input) to an electrical signal, converting mechanical motion from a button depress to an electrical signal, converting electrical signals to light signals (and vice-versa), etc. In these or other examples, “input-output state” refers to a type of input or a type of output for an electronic case as disclosed herein.

Further shown in FIG. 1, the modular electronic device system 100 can include an accessory device 108. In some implementations, the accessory device 108 can include another computing device. In other implementations, the accessory device 108 can include a peripheral input device that is connectable to a computing device (e.g., via a docked, wired, or wireless connection) such as a standalone keyboard, a number input pad (e.g., “tenkey” pad), a trackpad, a mouse, another pointer input device, an electronic stylus (e.g., a pointer tool or digital writing utensil), a graphic pen tablet, similar devices, and combinations thereof. In some examples, the accessory device 108 includes a power supply, such as a portable power bank, a wireless charger, etc.

Any of the features, components, parts, including the arrangements and configurations thereof shown in FIG. 1 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 1.

FIG. 2 illustrates the computing device 102 updating a user interface in accordance with one or more examples of the present disclosure. As shown, the computing device 102 comprises an electrical connector 202 and a user interface 204. As used herein, the term “electrical connector” can include one or more elements for the transmission of data and/or power between components connected to the electrical connector. In some examples, an electrical connector includes at least one of an electrical contact, magnetic contact, pin, port, socket, card reader, male-female connection, switch, or circuitry. In these or other examples, the computing device 102 can removably connect with another computing device, an electronic case, and/or an accessory device through the electrical connector 202.

The user interface 204 can be implemented using a display (e.g., 104) of the computing device 102 and a controller other computer elements of the computing device 102 implementing software instructions or other control instructions for the display, such as the components and elements discussed in connection with FIG. 10. In a first state, the user interface 204 can include or implement a first display profile 206. As used herein, the term “display profile” refers to a set of user interface settings. In some examples, a display profile can include user interface appearance settings (e.g., a font setting (e.g., font type, font size, etc.), a color setting, a graphical zoom setting, a setting controlling available applications or other electronically stored information (e.g., a directory setting (e.g., for email, phone contacts), a business setting, a personal setting, an access setting, a notification setting (e.g., time and method of notification, such as a notification banner, sound, visual alert, etc.), a gaming setting, etc.)). Myriad other user interface settings are herein contemplated.

The electronic case 106 is coupled (e.g., electrically and/or communicatively coupled) to the computing device 102. The electronic case 106 optionally includes one or more different components (as indicated via dashed lines). In some examples, the electronic case 106 can include an electrical connector 208. The electrical connector 208 can be the same as or similar to the electrical connector 202, such as by being a compatible connector to join to the electrical connector 202 in a paired manner (e.g., male-to-female physical connectors or a paired wireless connection (e.g., via BLUETOOTH®)). In other examples, the electrical connector 208 comprises a different type of electrical connector.

The electronic case 106 can further include a sensor 210. As used herein, the term “sensor” refers to a device configured to sense, detect, capture, measure, or estimate certain properties (whether light, magnitude of magnetic field, voltage, resistance, movement, vibration, etc.). Thus, a sensor can generate sensor data (i.e., output electrical signals or reactive changes in electrical properties of the sensor) based on a detected property. Examples of a sensor include a camera, image sensor, light detector, optical transducer, photovoltaic sensor (e.g., solar cell), photoresistor, phototransistor, photodiode, photodetector, pyroelectric detector, etc. Additional examples of a sensor include an ambient light sensor, photometer, light meter, illuminance meter, radiometer, optometer, datalogger, lux meter, chroma meter, spectrometer, spectrophotometer, spectroradiometer, charge coupled device, active-pixel sensor, etc. Still, other examples of sensors include different sensing devices, such as a temperature device, oxygen device, movement device, brain activity device, sweat gland activity device, breathing activity device, muscle contraction device, etc. Some particular examples of sensors include an electrooculography sensor, electrocardiogramsor, EKG sensor, hear rate variability sensor, blood volume pulse sensor, SpO2 sensor, compact pressure sensor, electromyography sensor, core-body temperature sensor, galvanic skin sensor, accelerometer, gyroscope, magnetometer, inclinometer, barometer, infrared sensor, global positioning system sensor, fingerprint scanner, etc.

The electronic case 106 can additionally (or alternatively) include an authentication chip 212. The authentication chip 212 can include a processor and/or memory device configured to generate, transmit, analyze, receive, or verify a connection signal (e.g., a digital handshake). In some cases, the authentication chip 212 can include a unique identifier (e.g., a hard-coded identifier) indicating the identity of the electronic case 106. The computing device 102 may comprise a sensor configured to detect and/or receive information from some or all components of the electronic case 106. For example, the sensor of the computing device 102 may receive information from the chip 212 or sensor 210 or detect magnets 216.

In some examples, the electronic case includes a signal transceiver 214. The signal transceiver 214 can transmit and receive signals. For instance, the signal transceiver 214 can relay an authentication signal from the authentication chip 212 to the computing device 102. As another example, the signal transceiver 214 can transmit a sleep signal or an awake signal to the computing device 102 (e.g., in response to the sensor 210 detecting the accessory device 108). In such a case, a sleep signal comprises computer-executable instructions for the computing device 102 to change to a sleep state in which the computing device 102 is inactive, in locked mode, powered off, in a battery-save mode, a display-off mode, etc. By contrast, a wake signal comprises computer-executable instructions for the computing device 102 to change to an awakened state in which the computing device 102 is active, unlocked, powered on, display-on mode, etc. In some embodiments, the signal transceiver 214 may be used to wirelessly detect other devices on or around the case 106. For example, the transceiver 214 may detect a wireless stylus positioned on the case 106 via a wireless signal output by the stylus, or it may detect and transfer data as a wireless network connection transceiver (e.g., antenna).

The electronic case 106 can include magnet(s) 216. The magnet(s) 216 can include one or more elements that produce a magnetic field. In one example, the magnet(s) 216 comprise a first magnet having a first polarity directed in a first direction and a second magnet having the opposite polarity directed in the first direction or parallel to the first direction.

The accessory device 108 can also include a variety of components. In some examples, the accessory device 108 includes an electrical connector 220, which can be the same as or similar to at least one of the electrical connectors 202, 208.

The accessory device 108 can also include one or more (e.g., an array of) magnets 222. For example, an array of magnets 222 can include a shaped configuration of magnets (e.g., a triangular-shaped configuration, a circular shaped configuration, a square-shaped configuration, a linear configuration, etc.). In another example, the array of magnets 222 can include a configuration of magnet polarities facing outward and away from the accessory device 108 (e.g., alternating positive-negative polarities, one positive polarity followed by two negative polarities, one negative polarity followed by two positive polarities, and so forth). In yet another example, the array of magnets 222 can include a particular number of magnets, a particular arrangement of magnetic field strengths or polarities, similar magnetic properties, or combinations thereof.

Based on the various components of the electronic case 106 and the accessory device 108, the electronic case 106 can identify the accessory device 108 in a variety of ways. For example, in some implementations, the electronic case 106 can detect the accessory device 108 via electrical connectors (e.g., the electrical connectors 208, 220). In such a case, the accessory device 108 can dock to or otherwise mate with the electronic case 106 via the electrical connectors 208, 220. In at least some examples, the electrical connectors 208, 220 are magnetically attracted to one another (e.g., using the array of magnets 222), thereby allowing the accessory device 108 to snap to the electronic case 106. Upon connection via the electrical connectors 208, 220, data and/or power can be transmitted therethrough. In this way, signals can also be transmitted between the accessory device 108 and the computing device 102.

For instance, the computing device 102 can receive a connection signal from the accessory device 108 through each of the electrical connectors 202, 208, 220. As used herein, the term “connection signal” refers to a signal comprising data packets with at least one of computer-executable instructions, an identifier indicating the type of accessory device (and in some cases, status information such as battery level), pairing information, display profile information, similar communicated information, or combinations thereof. In certain implementations, the authentication chip 212 of the electronic case 106 can verify the connection signal from the accessory device 108 (e.g., by comparing programmed or stored accessory device data with data from the connection signal). In turn, the electronic case 106 can transmit, to the computing device 102, an authentication signal in addition to (or alternatively to) the connection signal. The authentication signal can similarly include data packets with at least one of computer-executable instructions, verification information, a verified identifier indicating the type of detected accessory device (and in some cases, status information such as battery level), pairing information, display profile information, etc.

In other examples, the electronic case 106 can wirelessly connect to the accessory device 108. For instance, the electronic case 106 can detect the accessory device 108 via a wireless connection signal received at the signal transceiver 214 from the accessory device 108 via one or more wireless communication protocols, such as via a wireless local area network protocol, wireless area network protocol, wireless personal area network protocol, wide area protocol, etc. Some particular examples of wireless communication via such protocols include a Wi-Fi based communication, mesh network communication, BLUETOOTH® communication, near-field communication, low-energy communication, ZIGBEE® communication, Z-wave communication, and 6LoWPAN communication.

As another example, the electronic case 106 can detect the accessory device 108 using the sensor 210. For example, the sensor can detect a magnetic field associated with the array of magnets 222. Specifically, the sensor 210 can detect the specific properties of the magnetic field generated by the array of magnets 222. Thus, like a virtual signature, the sensor 210 can detect specific magnetic markers that identify the accessory device 108 (or at least distinguish the accessory device 108 from other accessory devices). Examples of magnetic markers can include polarity, magnitude or strength, sequence of magnets, position/arrangement of magnets, number of magnets, etc. Based on the detected sensor data representing the detected magnetic markers, the sensor 210 can generate a corresponding sensor signal. In some cases, the signal transceiver 214 can relay the sensor signal to the computing device 102 for identifying the accessory device 108. Additionally or alternatively, the authentication chip 212 can compare the sensor signal to magnetic markers for accessory devices and determine a match for identifying the accessory device 108 at the electronic case 106.

In response to detecting the accessory device 108, the computing device 102 can then update the user interface 204 (e.g., automatically and/or with confirmation via user input). In particular, the computing device 102 can update the user interface 204 from a first display profile 206 to a second display profile 218, as indicated by the arrow showing the transition in FIG. 2. For example, the detected accessory device 108 can correspond to a personal keyboard, and therefore, the computing device 102 can correspondingly update the user interface 204 to display one or more graphical representations based on the second display profile 218 (e.g., a personal display profile in which message contacts correspond to personal contacts, the internet browser corresponds to personal browser tabs or personal bookmarks, etc.). As another example, the detected accessory device 108 can correspond to a gaming keyboard, and therefore, the computing device 102 can correspondingly update the user interface 204 to display one or more graphical representations based on the second display profile 218 (e.g., a gaming display profile in which a display refresh rate for the computing device 102 is increased or maximized).

Any of the features, components, parts, including the arrangements and configurations thereof shown in FIG. 2 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 2.

FIG. 3 illustrates the computing device 102 updating a user interface in accordance with one or more examples of the present disclosure. In particular, FIG. 3 illustrates the computing device 102 updating a user interface in response to identifying an electronic case (e.g., a different electronic case). Examples of differing electronic cases can include electronic cases that differ in at least one of a material, size, color, protection rating, model number, SKU number, accessory device compatibility, electrical connectors, sensors, etc.

In these or other examples, a first electronic case 302 and a second electronic case 314 can comprise the same or similar elements described above in relation to the electronic case 106, such as electrical connectors 304, 316, sensors 306, 318, authentication chips 308, 320, signal transceivers 310, 322, and/or magnet(s) 312, 324. However, the first electronic case 302 and the second electronic case 314 can include certain differences of components. For example, the authentication chip 308 can include an identifier unique to the first electronic case 302, and the authentication chip 320 can include an identifier unique to the second electronic case 314. Similarly, for example, the magnet(s) 312 can include a first array of magnets unique to the first electronic case 302, and the magnet(s) 324 can include a second array of magnets unique to the second electronic case 314. In this way, the computing device 102 can, via sensor to detect the chips 308, 320 or magnets 312, 324 (or a lack thereof) distinguish between electronic cases (or no case) and generate corresponding user interfaces 204 based on display profiles 206, 218 specific to the electronic cases 302, 314.

To illustrate, upon connecting the first electronic case 302 to the computing device 102 via electrical connectors 202, 304, the authentication chip 308 can transmit an authentication signal through the electrical connectors 202, 304 and to the computing device 102. Based on the authentication signal identifying the first electronic case 302, the computing device 102 can generate the user interface 204 for display according to the first display profile 206. For example, the computing device 102 can display a red background based on the authentication signal indicating the first electronic case 302 comprises a red color.

Similarly, upon connecting the second electronic case 314 to the computing device 102 via electrical connectors 202, 316, the authentication chip 320 can transmit an authentication signal through the electrical connectors 202, 316 and to the computing device 102. Based on the authentication signal identifying the second electronic case 314, the computing device 102 can generate the user interface 204 for display according to the second display profile 218. For example, the computing device 102 can display a blue background based on the authentication signal indicating the second electronic case 314 comprises a blue color.

Any of the features, components, parts, including the arrangements and configurations thereof shown in FIG. 3 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 3.

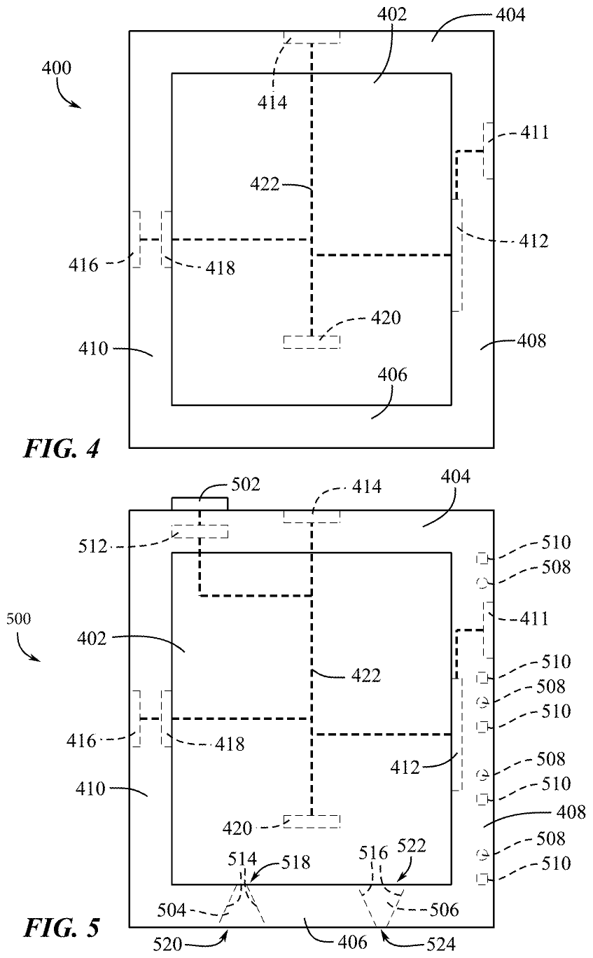

FIG. 4 illustrates a front view of an electronic case 400 in accordance with one or more examples of the present disclosure. As shown, the electronic case 400 comprises a rear surface 402 and sidewalls 404, 406, 408, 410. In some examples, the rear surface 402 is defined by a back panel attached to the sidewalls 404-410. In other examples, the rear surface 402 and the sidewalls 404-410 are integrally (or inseparably) formed together as a unibody piece.

Together, the rear surface 402 and the sidewalls 404-410 can define an interior portion (or internal volume) sized and shaped to receive the computing device 102, similar to how case 106 receives device 102 in FIG. 1. For example, the rear surface 402 and the sidewalls 404-410 can include length, width, and depth dimensions arranged to at least partially cover the rear and side surfaces of the computing device 102. In alternative examples of the electronic case 400, one or more of the sidewalls 404-410 can be omitted. In such event, one or more corresponding sides of the computing device 102 can be at least partially exposed (i.e., uncovered by the electronic case 400).

In these or other examples, the rear surface 402 and/or the sidewalls 404-410 can include a soft, compliant, non-marring material configured to contact the rear and side surfaces of the computing device 102 without scratching or blemishing the computing device 102. Examples of such material can include felt, fabric, foam, velvet, flexible plastic, leather, similar materials, and combinations thereof.

The electronic case 400 can further include certain electrical components that are in electrical communication with each other. As used herein, the term “electrical communication” refers to components that are configured to exchange electrical signals, directly or indirectly, between each other, whether unidirectionally or bidirectionally. In some embodiments, components or devices may be in electrical communication via a wired connection, a wireless connection, or both.

The electronic case 400 can include electrical connectors 412-420. The electrical connectors 411-420 can be the same as or similar to the electrical connectors discussed above in relation to FIGS. 2-3. In one example, however, at least one of the electrical connectors 411-420 can comprise a greater amount of surface area than an electrical connector for a computing device (e.g., electrical connector 202). The greater amount of surface area for one or more of the electrical connectors 411-420 can include a greater number of contacts or an increased size of contacts relative to a computing device electrical connector. In this way, an electrical connector of the electronic case 400 can provide certain functionality, such as an increased charging rate or an increased bandwidth for data transmission to the computing device.

In particular, the electronic case 400 can include an electrical connector 411 positioned on an exterior portion of the electronic case 400 at the sidewall 408. In addition, the electronic case 400 can include an electrical connector 412 positioned on an interior portion of the electronic case 400—specifically, the inner portion of the sidewall 408. In some examples, the electrical connector 411 and the electrical connector 412 are electrically connected (as indicated by the dashed lines in FIG. 4). It will be appreciated that the electrical connector 411 and the electrical connector 412 need not be positionally aligned along the sidewall 408, as demonstrated in FIG. 4. Thus, the electrical connector 411 and the electrical connector 412 can be arranged around other components not shown within the sidewall 408 (and/or to facilitate a thinner sidewall for a thinner profile). Accordingly, the electrical connector 411 and the electrical connector 412 can include a myriad of different spatial configurations.

Additionally or alternatively, the electronic case 400 can include an electrical connector 414 positioned on an exterior portion of the electronic case 400 at the sidewall 404 and/or an electrical connector 416 positioned on an exterior portion of the electronic case 400 at the sidewall 410. An electrical connector 418 can be positioned on an interior portion of the sidewall 410 and in electrical communication with the electrical connector 416. Further, in some implementations, an electrical connector 420 can be positioned on the rear surface 402.

In these or other examples, certain electrical connectors are configured to engage an electrical connector of the computing device 102. For instance, the electrical connectors 412, 418, 420 are configured to engage an electrical connector of the computing device 102. In some embodiments, the connectors 412, 418, 420 are engageable with different electrical connectors of the computing device 102. By contrast, other electrical connectors are configured to engage an electrical connector of an accessory device, such as the accessory device 108. For instance, the electrical connectors 411, 414, 416 are configured to engage an electrical connector of an accessory device.

Furthermore, electrical circuitry 422 can connect one or more electrical connectors to each other. The term “electrical circuitry” refers to electrical pathways, electrical components, etc. The electrical circuitry 422 can be embedded within the electronic case 400. For example, the electrical circuitry 422 can be embedded in one or more of the sidewalls 404-410. Additionally or alternatively, the electrical circuitry 422 can be embedded within the rear surface 402. Further, in some examples, multiple sets of electrical circuitry can be implemented (e.g., to connect certain electrical connectors and not other electrical connectors).

It will be appreciated that the foregoing electrical connectors and electrical circuitry can be implemented in myriad different ways. Multiple different electrical connectors of the electronic case 400 can provide a wide array of compatibility, including compatibility with different computing devices and/or accessory devices. In so doing, the electronic case 400 can obviate various adapters, dongles, and other hardware to provide compatibility with different computing devices and/or accessory devices.

Any of the features, components, parts, including the arrangements and configurations thereof shown in FIG. 4 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 4.

FIG. 5 illustrates a front view of an electronic case 500 in accordance with one or more examples of the present disclosure. As shown, the electronic case 500 can include at least one of the same or similar elements described above in relation to the electronic case 400 of FIG. 4. Additionally or alternatively, the electronic case 500 can include a variety of other components now discussed below.

In some examples, the electronic case 500 can include a button 502. The button 502 can be positioned on an exterior portion of the electronic case 500, such as on an exterior portion of the sidewall 404. When actuated, the button 502 can trigger transmission of a signal to an electrical connector (e.g., the electrical connectors 412, 418, 420). For example, actuation of the button 502 can cause one or more circuits to close, thereby allowing signal transmission through the electrical circuitry 422. As another example, actuation of the button 502 can cause a mechanical component (e.g., a plunger) to impinge or otherwise trigger a controller device to responsively transmit a signal to an electrical connector through the electrical circuitry 422.

In these or other examples, the button 502 can be linked to certain functionality or trigger certain interactions. For example, the button 502 can include an action button. The button 502 can therefore correspond to certain actions performed on a computing device, such as an “undo” button for a drawing application. In certain examples, the button 502 can be programmed or set to correspond to a specific action (e.g., on an application-by-application basis).

In yet another example, a sensor 512 can detect a user input at the button 502. To do so, the sensor 512 may detect, for the button 502, a change in electrical capacitance or resistance, light refraction, position, similar button properties or signals, or combinations thereof. In at least some examples, the button 502 is sensorally transparent to the sensor 512. That is, the button 502 can include a sensorally transparent surface conducive to measurement signals from the sensor 512 passing through the button 502. As used herein, the term “sensorally transparent” refers to the ability of measurement signals from a sensor (or signals configured to be provided to a sensor) to penetrate an object or surface. Thus, a sensorally transparent surface or object can include a type of material penetrable by a sensor measurement signal without substantial loss to the quality or accuracy of the sensor measurement signal (where in various embodiments, “substantial” can mean an amount greater than about 5%, about 10%, about 25%, about 50%, or greater than 50% discrepancy from a ground truth signal). For example, a sensorally transparent material can allow a heart rate sensor to accurately detect electrical, magnetic, or audio heart data indicative of a heart palpation, heartbeat, heart rhythm, etc. despite the sensorally transparent material being disposed between the heart rate sensor and the user. The sensor measurement signal can therefore be a wireless signal to and/or from a sensor, where the wireless signal comprises wavelike properties (e.g., frequency, amplitude, etc.) that allow the wireless signal to propagate through the sensorally transparent material.

Additionally or alternatively to detecting a user input at the button 502, the sensor 512 (or another sensor) can identify a biomarker. In one example, the biomarker is associated with a human finger in contact with the button 502. In these or other examples, a biomarker can include an identifying physical attribute (e.g., a fingerprint, facial profile, or iris/retinal pattern). In other examples, a biomarker can include a health-related metric, such as a blood-oxygen metric, a heart rate metric, a perspiration metric, etc. In these or other examples, sensor data representative of the biomarker can be transmitted through one or more electrical connectors to the computing device 102 (e.g., for unlocking the computing device 102, granting user permissions, etc.).

In one or more examples, the electronic case 500 can include an acoustic chamber. In certain implementations, the electronic case 500 includes multiple acoustic chambers. As used herein, the term “acoustic chamber” refers to shaped cutouts or channels that augment sound waves into or out of the electronic case. For example, an acoustic chamber can include a v-shaped channel defined by internal sidewalls (e.g., to form a tapered cross-section). In such an example, an acoustic chamber can increase or decrease an amplitude or a magnitude of sound waves. As another example, acoustic chamber can redirect or orient sound waves in a particular direction (e.g., away from a speaker, toward a microphone, or toward or away from a user-facing surface).

To illustrate, FIG. 5 depicts the electronic case 500 as including an acoustic chamber 504 and an acoustic chamber 506. The acoustic chamber 504 is defined by internal walls 514. The internal walls 514 can form a tapered cross-section between openings 518, 520. In at least one example, the acoustic chamber 504 comprises a speaker chamber configured to amplify or spatially direct sound waves away from a speaker associated with the computing device 102 (hence the opening 520 being larger than the opening 518).

Similarly, the acoustic chamber 506 is defined by internal walls 516. The internal walls 516 can form a tapered cross-section between openings 522, 524. In at least one example, the acoustic chamber 506 comprises a microphone chamber configured to amplify or spatially direct sound waves into a microphone associated with the computing device 102 (hence the opening 522 being larger than the opening 520).

The electronic case 500 can include a variety of sensors as disclosed herein. In particular, the electronic case 500 can include sensors 508. The sensors 508 can include a myriad of different configurations, positions, spacing, etc. As shown, however, the sensors 508 are positioned along a single sidewall 408. In this position, for instance, the sensors 508 can detect an accessory device adjacent to the sidewall 408. For example, the sensors 508 can detect an accessory device positioned within a wireless sensor range of the sensors 508. The term “wireless sensor range” refers to a distance range or angle range defining a sensor's effective field of view or detectability. In at least some examples, the wireless sensor range of the sensors 508 extends at least from the position of the sensors 508 to the exterior surface of the sidewall 408. In particular examples, the wireless sensor range of the sensors 508 extends beyond the exterior surface of the sidewall 408 (e.g., to at least three inches beyond the sidewall, to at least five inches beyond the sidewall, to at least ten inches beyond the sidewall, etc.).

In these or other examples, the sensors 508 can detect an electronic stylus (or other accessory device) positioned adjacent to the sidewall 408. For example, the sensors 508 can detect a virtual signature of the electronic stylus, such as a particular magnetic field generated by magnets associated with the electronic stylus.

Additionally or alternatively, the electronic case 500 can include magnets 510. The magnets 510, like the sensors 508, can be positioned in myriad different configurations and positions. However, as shown in FIG. 5, the magnets 510 can be positioned in the sidewall 408 (e.g., where the magnets 510 can magnetically attract an accessory device to abut the sidewall 408). It will be appreciated though that the magnets 510 can be positioned in other sidewalls and/or embedded in the rear surface 402 (e.g., to magnetically attract one or more other accessory devices).

Any of the features, components, parts, including the arrangements and configurations thereof shown in FIG. 5 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 5.

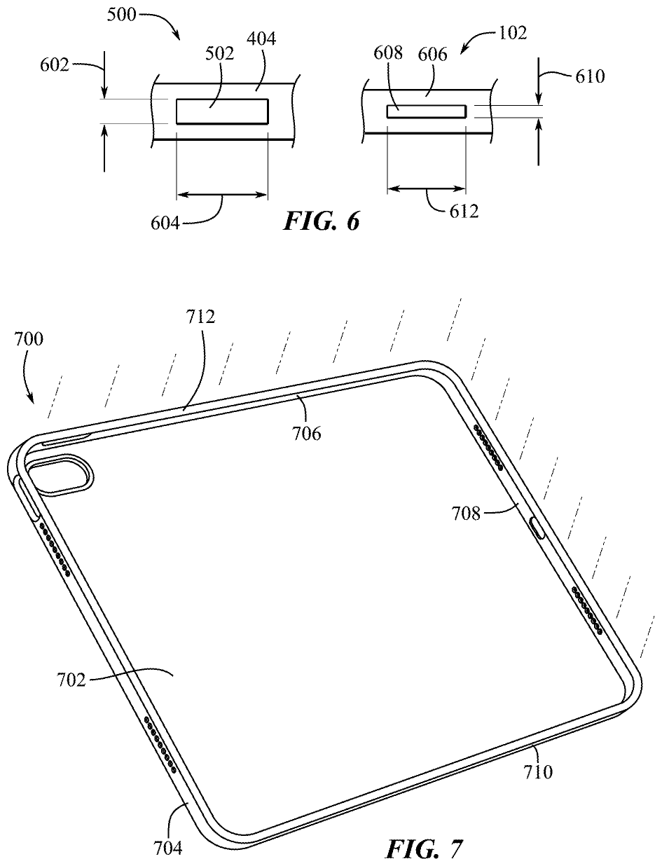

FIG. 6 illustrates a side view of a portion of the electronic case 500 and a portion of the computing device 102 (adjacent to each other for purposes of illustration and discussion) in accordance with one or more examples of the present disclosure. As shown in FIG. 6, the electronic case 500 comprises the button 502 positioned on the sidewall 404. Similarly, the computing device 102 can include a button 608 positioned on a sidewall 606 of the computing device 102. In these or other examples, the button 502 can include a greater amount of surface area available for contact relative to the button 608. For example, the button 502 can have a width 602 that is greater than a width 610 for the button 608. As another example, the button 502 can have a length 604 that is greater than a length 612 for the button 608.

Due to the relatively increased amount of surface area available for contact, the button 502 can facilitate various functionality that the computing device 102 may otherwise be unable to do with a smaller button, such as the button 608. For example, the button 502 can be sized and shaped as having a surface area conducive to identifying a biomarker in response to a user input at the button 502. To illustrate, the button 502 can be sized and shaped to contact a finger such that a sensor associated with the button 502 can identify at least a partial fingerprint from the finger in contact with the button 502. As another example, the button 502 can provide a boost in capacitive response (or another amplified signal) based on the increased surface area of the button 502.

Although a single button 502 is illustrated, it will be appreciated that an electronic case of the present disclosure can include additional buttons. For example, an electronic case as disclosed herein can include multiple touch identification buttons.

Any of the features, components, parts, including the arrangements and configurations thereof shown in FIG. 6 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 6.

FIG. 7 illustrates an electronic case 700 in accordance with one or more examples of the present disclosure. The electronic case 700 can comprise the same or similar elements described above. In particular, electronic case 700 comprises a back panel 702, which is the same as or similar to the rear surface 402 described above. Likewise, electronic case 700 comprises sidewalls 704-710, which are the same as or similar to the sidewalls 404-410 discussed above.

Additionally, electronic case 700 can include a periphery light 712. The periphery light 712 can extend along a portion of an edge of a sidewall. For example the periphery light 712 can extend along at least one edge of the sidewalls 704-710. In at least one example, the periphery light 712 extends along each edge of the sidewalls 704-710.

In these or other examples, the periphery light 712 can include a light configured to switch on and off. In certain implementations the periphery light 712 can include a momentarily flashable light (e.g., for short burst(s) of light to take a photo or video, to signal an emergency message, etc.), a flashlight (e.g., to leave on in an illuminated state for a period of time), a colored light (e.g., an ambience light, a decorative light corresponding to the color of the electronic case 700 and/or the computing device 102 not shown), etc.

The periphery light 712 can be triggered in a variety of ways. In some examples, the computing device 102 can transmit a signal to the electronic case 700 through one or more electrical connectors (not shown) and/or through wireless transmission. In such a case, the signal can include computer-executable instructions to turn the periphery light 712 on/off (e.g., to flash when the computing device 102 captures a digital image, to turn a certain color upon a timer lapsing on the computing device 102, etc.). In other examples, the periphery light 712 can be triggered at the electronic case 700 (e.g., via one or more buttons not shown).

Any of the features, components, parts, including the arrangements and configurations thereof shown in FIG. 7 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 7.

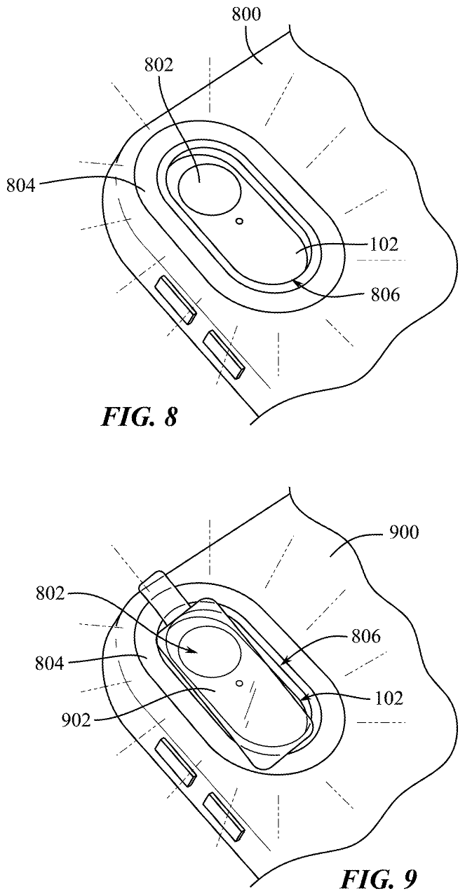

FIG. 8 illustrates an example of the computing device 102 positioned within a portion of the electronic case 800 in accordance with one or more examples of the present disclosure. The electronic case 800 can include the same or similar elements described above in relation to the foregoing figures.

In some examples, a computing device 102 includes a camera 802. The camera 802 can include one or more optical lenses and/or light sensors for capturing a digital image with the computing device 102.

In these or other examples, the electronic case 800 includes a flash bar 804. The flash bar 804 can extend along a periphery that defines a cutout 806 sized and shaped for the camera 802. In some examples, the flash bar 804 extends along a portion of the periphery that defines the cutout 806. In other examples, the flash bar 804 extends along an entirety of the periphery that defines the cutout 806.

In certain examples, the flash bar 804 can include a light configured to switch on and off. In certain implementations the flash bar 804 can include a momentarily flashable light (e.g., for short burst(s) of light to take a photo or video, to signal an emergency message, etc.), a flashlight (e.g., to leave on in an illuminated state for a period of time), a colored light (e.g., an ambience light, a decorative light corresponding to the color of the electronic case 800 and/or the computing device 102 not shown), etc.

Like the periphery light 712 of FIG. 7, the flash bar 804 can be triggered in a variety of ways. In some examples, the computing device 102 can transmit a signal to the electronic case 800 through one or more electrical connectors (not shown) and/or through wireless transmission. In such a case, the signal can include computer-executable instructions to turn the flash bar 804 on/off (e.g., to flash when the computing device 102 captures a digital image, to turn a certain color upon a timer lapsing on the computing device 102, etc.). In other examples, the flash bar 804 can be triggered at the electronic case 800 (e.g., via one or more buttons not shown).

Any of the features, components, parts, including the arrangements and configurations thereof shown in FIG. 8 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 8.

FIG. 9 illustrates an example of the computing device 102 positioned within a portion of an electronic case 900 in accordance with one or more examples of the present disclosure. As shown in FIG. 9, the electronic case 900 comprises the same or similar elements described above in relation to the electronic case 800 of FIG. 8.

In addition, however, the electronic case 900 comprises a lens adapter 902. The lens adapter 902 be positioned above the camera 802. For example, the lens adapter 902 can at least partially overlap the cutout 806. In some examples, the lens adapter 902 is formed fit to the size and shape of the cutout 806.

In these or other examples, the lens adapter 902 includes an optical lens configured to augment the visual field of view for the camera 802 (e.g., for improved camera performance). In certain examples, the lens adapter 902 is configured to augment a light signal received at the camera 802 (e.g., an illuminance of environmental light). Additionally or alternatively, the lens adapter 902 is configured to augment focal properties of the camera 802 (e.g., a focal length). Certain examples of the lens adapter 902 include a zoom lens, a fish-eye lens, etc.

The lens adapter 902 can be removably attached to the electronic case 900 in a variety of ways. In some examples, the lens adapter 902 is clipped onto the electronic case 900. In another example, the lens adapter 902 is magnetically attached to the electronic case 900.

In one or more examples, at least one of electronic case 900 or the computing device 102 can detect the lens adapter 902. For example, the computing device 102 can detect one or more changes to image properties, lighting properties, etc. via the camera 802. As another example, the electronic case 900 can include one or more sensors (not shown) that can detect the presence of the lens adapter 902 (e.g., via Hall effect sensors configured to detect a magnetic periphery of the lens adapter 902).

Any of the features, components, parts, including the arrangements and configurations thereof shown in FIG. 9 can be included, either alone or in any combination, in any of the other examples of devices, features, components, and parts shown in the other figures. Likewise, any of the features, components, parts, including the arrangements and configurations thereof shown in the other figures can be included, either alone or in any combination, in the example of the devices, features, components, and parts shown in FIG. 9.

FIG. 10 illustrates a high-level block diagram of a computer system 1000 that can be used to implement embodiments of the present disclosure. In various embodiments, the computer system 1000 can comprise various sets and subsets of the components shown in FIG. 10. Thus, FIG. 10 shows a variety of components that can be included in various combinations and subsets based on the operations and functions performed by the system 1000 in different embodiments. For example, the computer system 1000 can be part of the computing device 102 (or an accessory device or an electronic case) described above in connection with the foregoing figures. It is noted that, when described or recited herein, the use of the articles such as “a” or “an” is not considered to be limiting to only one, but instead is intended to mean one or more unless otherwise specifically noted herein.

The computer system 1000 can comprise a central processing unit (CPU) or processor 1002 connected via a bus 1004 for electrical communication to a memory device 1006, a power source 1008, an electronic storage device 1010, a network interface 1012, an input device adapter 1016, and an output device adapter 1020. For example, one or more of these components can be connected to each other via a substrate (e.g., a printed circuit board or other substrate) supporting the bus 1004 and other electrical connectors providing electrical communication between the components. The bus 1004 can comprise a communication mechanism for communicating information between parts of the system 1000.

The processor 1002 can be a microprocessor or similar device configured to receive and execute a set of instructions 1024 stored by the memory 1006. The memory 1006 can be referred to as main memory, such as random access memory (RAM) or another dynamic electronic storage device for storing information and instructions to be executed by the processor 1002. The memory 1006 can also be used for storing temporary variables or other intermediate information during execution of instructions executed by the processor 1002. The processor 1002 can include one or more processors or controllers, such as, for example, a CPU for the computing device 102 in general and a touch controller or similar sensor or I/O interface used for controlling and receiving signals from the display 104 and any other sensors being used. The power source 1008 can comprise a power supply capable of providing power to the processor 1002 and other components connected to the bus 1004, such as a connection to an electrical utility grid or a battery system.

The storage device 1010 can comprise read-only memory (ROM) or another type of static storage device coupled to the bus 1004 for storing static or long-term (i.e., non-dynamic) information and instructions for the processor 1002. For example, the storage device 1010 can comprise a magnetic or optical disk (e.g., hard disk drive (HDD)), solid state memory (e.g., a solid state disk (SSD)), or a comparable device.

The instructions 1024 can comprise information for executing processes and methods using components of the system 1000. Such processes and methods can include, for example, the connection processes described herein for connecting an electronic case to a computing device, connecting an accessory device to an electronic case, changing a user interface of a computing device (e.g., as described in connection with FIGS. 2 and 3), detecting an electronic case or signals from an electronic case by the computing system 1000, etc.

The network interface 1012 can comprise an adapter for connecting the system 1000 to an external device via a wired or wireless connection. For example, the network interface 1012 can provide a connection to a computer network 1026 such as a cellular network, the Internet, a local area network (LAN), a separate device capable of wireless communication with the network interface 1012, other external devices or network locations, and combinations thereof. In one example embodiment, the network interface 1012 is a wireless networking adapter configured to connect via WI-FI®, BLUETOOTH®, BLE, Bluetooth mesh, or a related wireless communications protocol to another device having interface capability using the same protocol. In some embodiments, a network device or set of network devices in the network 1026 can be considered part of the system 1000. In some cases, a network device can be considered connected to, but not a part of, the system 1000.

The input device adapter 1016 can be configured to provide the system 1000 with connectivity to various input devices such as, for example, an electronic case (e.g., the electronic cases 106, 302, 314, 400, 500, 700, 800, and 900), an accessory device (e.g., the accessory device 108), a touch input device 1013 (e.g., a standalone trackpad, fingerprint reader, haptic glove, etc.), related devices, and combinations thereof.

The output device adapter 1020 can be configured to provide the system 1000 with the ability to output information to a user, such as by providing visual output using one or more displays 1032, by providing audible output using one or more speakers 1035, or providing haptic feedback sensed by touch via one or more haptic feedback devices 1037. Other output devices can also be used. The processor 1002 can be configured to control the output device adapter 1020 to provide information to a user via the output devices connected to the adapter 1020.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A modular electronic device system, comprising:
a portable computing device comprising a rear surface and a sidewall surface; and
an electronic case sized and shaped to engage at least the rear surface of the portable computing device, the electronic case comprising at least one of:
an electrical connector;
a lens adapter; or
an acoustic chamber,
wherein the electronic case is configured to augment a signal into or out of the portable computing device via the electrical connector, the lens adapter, or the acoustic chamber; and
wherein the signal comprises an electrical signal, a light signal, or a sound signal.

2. The modular electronic device system of claim 1, wherein augmentation of the signal comprises at least one of:
amplifying a magnitude of the signal;
reducing the signal; or
converting the signal from one input-output state to another input-output state.

3. The modular electronic device system of claim 1, wherein:
the portable computing device comprises a first electrical connector positioned on one of the sidewall surface or the rear surface;
the electronic case comprises a second electrical connector electrically connectable to the first electrical connector, the second electrical connector positioned on an interior portion of the electronic case; and
a third electrical connector is positioned on an exterior portion of the electronic case, the third electrical connector being electrically connected to the second electrical connector, and the third electrical connector being electrically connectable to a fourth electrical connector of an accessory device.

4. The modular electronic device system of claim 3, wherein:
the first electrical connector comprises a first throughput capacity for power or data transmission; and
the third electrical connector comprises a second throughput capacity for the power or data transmission, the second throughput capacity being greater than the first throughput capacity.

5. The modular electronic device system of claim 3, wherein:
upon connection of the third electrical connector to the fourth electrical connector, the portable computing device is configured to receive a connection signal from the accessory device through each of the first, second, third, and fourth electrical connectors; and
in response to receiving the connection signal, the portable computing device is configured to update a display profile specific to the accessory device.

6. The modular electronic device system of claim 5, wherein the electronic case further comprises an authentication chip in electrical communication with at least the third electrical connector, the authentication chip configured to:
verify the connection signal from the accessory device; and
transmit an authentication signal to the portable computing device.

7. The modular electronic device system of claim 3, wherein the third electrical connector comprises a greater amount of contact surface area relative to the first electrical connector.

8. The modular electronic device system of claim 3, further comprising an electrical controller positioned between the second electrical connector and the third electrical connector, the electrical controller being configured to alter an electrical signal passing between the accessory device and the portable computing device.

9. The modular electronic device system of claim 3, wherein:
the electronic case comprises a first sidewall and a second sidewall;
the second electrical connector is positioned on an interior surface of the first sidewall; and
the third electrical connector is positioned on an exterior surface of the second sidewall.

10. The modular electronic device system of claim 3, wherein:
the electronic case comprises:
a sidewall configured to engage the sidewall surface of the portable computing device; and
a backing configured to engage the rear surface of the portable computing device;
the second electrical connector is positioned on an interior surface of at least one of the sidewall or the backing; and
the third electrical connector is positioned on an exterior surface of at least one of the sidewall or the backing.

11. An electronic case, comprising:
a rear surface;
sidewalls protruding perpendicularly away from the rear surface;
an interior portion defined by the rear surface and the sidewalls, the interior portion sized and shaped to receive a body portion of a portable computing device;
an exterior surface opposing the interior portion; and
a sensor disposed within the interior portion or embedded within one of the sidewalls, the sensor comprising a wireless detection range that extends at least to the exterior surface, the sensor being configured to:
detect an accessory device when the accessory device is positioned within the wireless detection range of the sensor; and
transmit a signal to the portable computing device, the signal identifying the accessory device and a user interface setting associated with the accessory device.

12. The electronic case of claim 11, wherein the accessory device comprises an electronic stylus.

13. The electronic case of claim 11, wherein the sensor is configured to detect a first magnetic array for a first accessory device and a second magnetic array for a second accessory device.

14. The electronic case of claim 11, further comprising a set of magnets embedded in at least one of the sidewalls.

15. The electronic case of claim 11, wherein the user interface setting comprises at least one of a color preference, font preference, notification preference, or contact directory preference.

16. The electronic case of claim 11, further comprising an additional sensor embedded within the rear surface, the additional sensor configured to:
detect a magnetic field emitted from an accessory device; and
transmit at least one of a wake signal or a sleep signal in response to detecting the magnetic field.

17. A modular electronic device system, comprising:
a tablet computing device, comprising:
a body portion including a rear surface; and
a display portion positioned opposite the rear surface, the display portion configured to generate a first graphical representation for display within a user interface, the first graphical representation corresponding to a first display profile; and
an electronic case, comprising:
a panel sized and shaped to cover at least the rear surface of the tablet computing device; and
a sensor disposed on or within the panel, the sensor configured to detect an accessory device, wherein:
the sensor is configured to generate a signal receivable by the tablet computing device in response to detection of the accessory device; and
in response to receiving the signal, the tablet computing device is configured to update the user interface by generating a second graphical representation for display, the second graphical representation corresponding to a second display profile that differs from the first display profile.

18. The modular electronic device system of claim 17, further comprising a housing that includes the panel and sidewalls integrated with the panel, at least one of the sidewalls defining an acoustic chamber to amplify or spatially direct sound waves into or away from the tablet computing device.

19. The modular electronic device system of claim 18, wherein the acoustic chamber comprises a tapered cross-section defined by internal walls within the housing.

20. The modular electronic device system of claim 18, wherein the acoustic chamber comprises:
a first opening oriented towards an interior portion of the housing; and
a second opening oriented towards an exterior portion of the housing, wherein the second opening is smaller than the first opening.

21. The modular electronic device system of claim 18, wherein the housing comprises:
an electrical contact exposed on an interior surface of the housing;
electrical circuitry connected to the electrical contact, the electrical circuitry embedded within the housing; and
an exterior button that, when actuated, triggers an electrical signal through the electrical circuitry to the electrical contact.

22. The modular electronic device system of claim 17, wherein the electronic case further comprises an additional sensor configured to detect a biomarker.

23. The modular electronic device system of claim 22, wherein the biomarker is associated with a human finger.

24. The modular electronic device system of claim 23, wherein an exterior button is sensorally transparent to the additional sensor to allow detection of the biomarker.
